(19) United States
(12) Patent Application Publication
(10) Pub. No.: US 2021/0406523 A1
(43) Pub. Date: Dec. 30, 2021

(54) METHOD AND DEVICE FOR DETECTING LIVING BODY, ELECTRONIC DEVICE AND STORAGE MEDIUM

(71) Applicant: SHENZHEN SENSETIME TECHNOLOGY CO., LTD., Shenzhen (CN)

(72) Inventors: Hongbin ZHAO, Shenzhen (CN); Wenzhong JIANG, Shenzhen (CN); Yi LIU, Shenzhen (CN); Siting HU, Shenzhen (CN); Junqiang LI, Shenzhen (CN)

(21) Appl. No.: 17/471,261

(22) Filed: Sep. 10, 2021

Related U.S. Application Data
(63) Continuation of application No. PCT/CN2020/087861, filed on Apr. 29, 2020.

(30) Foreign Application Priority Data
Aug. 19, 2019 (CN) 201910763887.2

(51) Int. Cl. G06K 9/00; G06K 9/62; G06T 7/73

(52) U.S. Cl. CPC G06K 9/00281; G06K 9/00255; G06T 7/74; G06K 9/6215; G06K 9/00906

(57) ABSTRACT

Provided are a method and device for detecting a living-body, and a storage medium. The method includes that: a first image captured by a first camera is acquired, and face detection processing is performed on the first image; a second image captured by a second camera is acquired responsive to detecting that the first image includes a face, where the first camera and the second camera are different types of cameras; and face detection processing is performed on the second image, and responsive to detecting that the second image includes a face, a living-body detection result is obtained based on a matching result of the face detected in the first image and the face detected in the second image.

### CROSS-REFERENCE TO RELATED APPLICATIONS

This application is a continuation of International Patent Application No. PCT/CN2020/087861, filed on Apr. 29, 2020, which claims priority to Chinese Patent Application No. 201910763887.2, filed on Aug. 19, 2019. The disclosures of International Patent Application No. PCT/CN2020/087861 and Chinese Patent Application No. 201910763887.2 are hereby incorporated by reference in their entireties.

### BACKGROUND

At present, face recognition technologies have been widely used. In daily life, face recognition may be applied to account registration, identity authentication and other aspects. As a result, living-body detection has become a technical research hot spot in recent years due to attack of a non-living body on the face recognition.

In existing living-body detection, features of a living body are generally detected by use of images acquired by a single camera only, and the detection accuracy of this approach is low.

### SUMMARY

Embodiments of the disclosure relate to the technical field of computer vision, and particularly to a method and device for detecting a living body, an electronic device and a storage medium.

The embodiments of the disclosure provide a method for detecting a living body, which may include the following operations. A first image captured by a first camera is acquired, and face detection processing is performed on the first image. Responsive to detecting that the first image includes a face, a second image captured by a second camera is acquired, where the first camera and the second camera are different types of cameras. Face detection processing is performed on the second image, and responsive to detecting that the second image includes a face, a living-body detection result is obtained based on a matching result of the face in the first image and the face in the second image.

Embodiments of the disclosure provide a device for detecting a living body, which includes a first detection module, an acquisition module and a second detection module. The first detection module is configured to acquire a first image captured by a first camera and perform face detection processing on the first image. The acquisition module is configured to acquire a second image captured by a second camera responsive to detecting that the first image includes a face, where the first camera and the second camera are different types of cameras. The second detection module is configured to perform face detection processing on the second image and, responsive to detecting that the second image includes a face, obtain a living-body detection result based on a matching result of the face in the first image and the face in the second image.

Embodiments of the present disclosure provide an electronic device, which may include: a processor; and a memory configured to store instructions executable by the processor. The processor may be configured to execute the instructions stored in the memory to implement the method as mentioned above.

Embodiments of the present disclosure provide a computer-readable storage medium, having stored thereon computer program instructions, where the computer program instructions, when being executed by a processor, cause the processor to implement the method as mentioned above.

### BRIEF DESCRIPTION OF THE DRAWINGS

It is to be understood that the above general description and the following detailed description are only exemplary and explanatory and not intended to limit the embodiments of the present disclosure. Other features and aspects of the embodiments of the present disclosure may become clear according to the following detailed descriptions made to exemplary embodiments with reference to the drawings.

The accompanying drawings, which are incorporated in and constitute a part of this specification, illustrate embodiments consistent with the present disclosure and, together with the specification, serve to describe the technical solutions of the embodiments of the present disclosure.

FIG. 1 is a flowchart of a method for detecting a living body according to an embodiment of the present disclosure.

FIG. 2 is a flowchart of S30 in a method for detecting a living body according to an embodiment of the present disclosure.

FIG. 3 is a flowchart of S32 in a method for detecting a living body according to an embodiment of the present disclosure.

FIG. 4 is a schematic diagram of a process for detecting a living body according to an embodiment of the present disclosure.

FIG. 5 is a block diagram of a device for detecting a living body according to an embodiment of the present disclosure.

FIG. 6 is a block diagram of an electronic device according to an embodiment of the present disclosure.

FIG. 7 is a block diagram of another electronic device according to an embodiment of the present disclosure.

### DETAILED DESCRIPTION

Each exemplary embodiment, feature and aspect of the disclosure will be described below with reference to the drawings in detail. The same reference signs in the drawings represent components with the same or similar functions. Although each aspect of the embodiments is shown in the drawings, the drawings are not required to be drawn to scale, unless otherwise specified.

Herein, special term “exemplary” refers to “as an example, embodiment or illustration”. Herein, any “exemplarily” described embodiments may not be explained to be superior to or better than other embodiments.

In the disclosure, term “and/or” is only an association relationship describing associated objects and represents that three relationships may exist. For example, A and/or B may represent three conditions: i.e., independent existence of A, existence of both A and B and independent existence of B. In addition, term “at least one” in the disclosure represents any one of multiple or any combination of at least two of multiple. For example, including at least one of A, B and C may represent including any one or more elements selected from a set formed by A, B and C.

In addition, for describing the disclosure better, many specific details are presented in the following specific implementation modes. It is understood by those skilled in the art that the disclosure may still be implemented even without some specific details. In some examples, methods, means, components and circuits known very well to those skilled in the art are not described in detail, to highlight the subject of the disclosure.

An execution body of a method for detecting a living body in the embodiments of the disclosure may be an image processing device. For example, the living-body detection method may be executed by a terminal device or a server or another processing device. The terminal device may be User Equipment (UE), a mobile device, a user terminal, a terminal, a cell phone, a cordless phone, a PDA, a handheld device, a computing device, a vehicle device, a wearable device, an identity verification device and the like. In some possible implementation modes, the living-body detection method may be implemented in a manner that a processor calls computer-readable instructions stored in a memory.

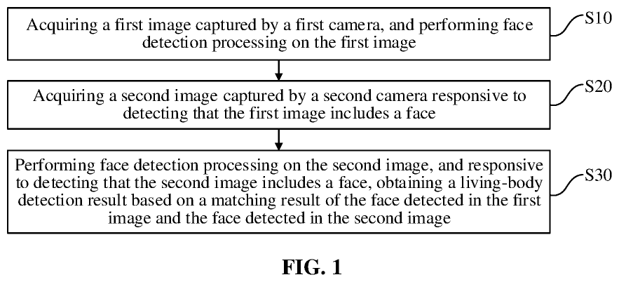

FIG. 1 is a flowchart of a method for detecting a living body according to an embodiment of the disclosure. As shown in FIG. 1, the method for detecting a living body includes the following operations S10, S20 and S30.

In operation S10, a first image captured by a first camera is acquired, and face detection processing is performed on the first image.

In some embodiments, the method for detecting a living body in the embodiment of the disclosure may be applied to any application scenario that requires execution of living-body detection. For example, the living-body detection method of the embodiment of the disclosure may be applied to scenarios such as input of face information, payment verification, identity verification and the like, which is not limited in the embodiment of the disclosure. Through the method for detecting a living body in the embodiment of the disclosure, whether a target person corresponding to a face in a collected image is living or not may be recognized. In addition, an electronic device for performing the living-body detection method in the embodiment of the disclosure may be configured with two cameras, such as the first camera and a second camera. The first camera and the second camera are of different types. For example, the first camera may be an RGB camera, and the second camera may be an IR camera. The first camera and the second camera may have the same imaging scales. The above is only exemplary and is not limited by the present application.

In some embodiments, the first image captured by the first camera may be acquired at first. The first image may be an image collected in real time by the first camera. For example, under the condition that an instruction of performing living-body detection is received, an instruction of starting the first camera is sent to the first camera, and the first image is captured by the first camera. The first image may be a color image (an RGB image).

In some embodiments, after the first image is acquired, face detection processing may be performed on the first image. The first image captured by the first camera may include one or more faces or may also not include any face. Through face detection processing, information of whether the first image includes any face or not, a position of an included face and the like may be recognized. In the embodiment of the disclosure, face detection processing may be performed through a neural network capable of recognizing faces. For example, the neural network may include at least one convolutional layer that performs feature extraction on the first image, and face detection and classification are performed through a fully connected layer. The neural network implementing face detection in the embodiment of the disclosure is not specifically limited to the abovementioned embodiment, and face detection may also be implemented through another neural network having a face recognition function, such as a region proposal network.

In operation S20, responsive to detecting that the first image includes a face, a second image captured by a second camera is acquired. The first camera and the second camera are different types of cameras.

In some embodiments, a face detection result of the first image may be obtained through the operation S10. The face detection result may include the information of whether the first image includes any face or not, and under the condition that the face is detected, may also include position information corresponding to the face, such as position information of a face detection box. Responsive to detecting that the first image includes the face, the second image captured by the second camera may further be acquired. As mentioned in the above examples, the second camera is a camera different from the first camera. The second camera may be an IR camera, and correspondingly, the collected second image is an IR image.

In some embodiments, the second image captured by the second camera is acquired in at least one of the following manners. Under the condition that the first image is captured by the first camera, the second image captured by the second camera is acquired; and under the condition of detecting that the first image includes the face, the second image captured by the second camera is acquired.

In an example, under the condition that the face is detected in the first image, a starting instruction may be sent to the second camera to start the second camera and collect images through the second camera, so as to acquire the second image captured by the second camera. That is, the second image acquired may be a second image captured by the second camera at a moment when the face is detected in the first image. Or, in another example, the second camera may also be started at the same time when the first camera is started, and the images captured by the second camera are stored in real time. Under the condition of detecting that the first image includes the face, the second image captured by the second camera may be acquired. The second image may be a second image captured by the second camera at a moment when the first image captured by the first camera is acquired, or may also be a second image captured by the second camera at any moment in a process from a moment when the first image is captured to the moment when the face in the first image is detected.

In some embodiments, if no face is detected in the first image, a new first image may be captured by the first camera to re-execute the method for detecting a living-body.

In operation S30, face detection processing is performed on the second image, and responsive to detecting that the second image includes a face, a living-body detection result is obtained based on a matching result of the face detected in the first image and the face detected in the second image.

In some embodiments, face detection processing may be performed on the second image after the second image is obtained, similar to the face detection processing of the first image. Face detection processing may also be performed on the second image through the neural network capable of implementing face detection. The second image may be input to the face detection neural network, and whether the second image includes any face or not and position information of the included face are recognized through the face detection neural network.

In some embodiments, the living-body detection result may be determined according to a face detection result of the second image. For example, if no face is detected in the second image, it may be indicated that the face detected in the first image is a non-living bod. In this case, the first image may include a glossy print or an electronic photo, and it may be directly determined that the face in the first image is a non-living body.

In some embodiments, the living-body detection result may also be determined based on the matching result of the face in the first image and the face in the second image when detecting that the second image includes the face. The face detection results of the images captured by the two types of cameras are combined. For example, under the condition that a face matched with the face in the first image is detected in the second image, living-body detection may be implemented based on the two matched faces, or, under the condition that no face matched with the face in the first image is detected in the second image, it may be determined that the face in the first image is a non-living body.

In the embodiment of the disclosure, the face detection results of the images captured by the two types of cameras are combined to determine a face matching result of the two images, and the living-body detection result is obtained according to the matching result. As a result, the detection accuracy is improved.

The embodiments of the disclosure will be described below in combination with the drawings in detail. As mentioned in the abovementioned embodiment, under the condition that the face is detected in the first image, living-body detection may be performed according to the face detection result of the second image captured by the second camera to obtain the living-body detection result.

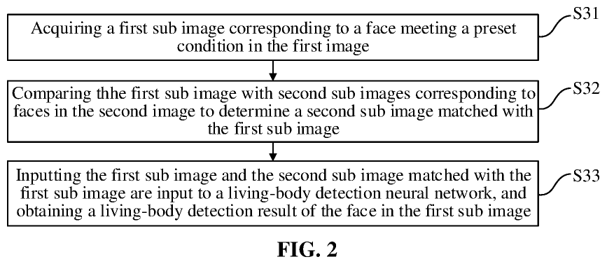

FIG. 2 is a flowchart of the operation S30 in a method for detecting a living body according to an embodiment of the disclosure. In the embodiment of the disclosure, the operation that the living-body detection result is obtained based on the matching result of the face detected in the first image and the face detected in the second image includes the following operations S31, S32 and S33.

In operation S31, a first sub image corresponding to a face that meets a preset condition is acquired in the first image.

In some embodiments, under the condition that the face detection result of the second image indicates that no face is detected, it may be indicated that the face in the first image is a non-living body. Under the condition that a face is detected in the second image, an image region corresponding to the face that meets the preset condition may be selected from the first image, where the image region is the first sub image.

As mentioned in the above embodiment, the face detection result may include position information of the detected face. The position information may be a position of a detection box corresponding to the detected face, and may be represented in coordinates, for example, represented as (x1, x2, y1, y2), where (x1, y1) and (x2, y2) are position coordinates of two diagonal vertexes of the detection box respectively. A position region where each face detected in the first image and the second image is located may be determined according to the position coordinates. The above is only an exemplary description, and the position region where the face is located may also be represented in another form.

In the embodiment of the disclosure, a face having a largest area in the first image may be determined as the face meeting the preset condition, and correspondingly, a position region where the face having the largest area is located may be determined as the first sub image. For example, in case of face authentication or other situations that require living-body detection, a face corresponding to a largest regional area in an image may be determined as a face to be detected, and in such case, an image corresponding to the position region of the face with the largest area may be determined as the first sub image corresponding to the face that meets the preset condition. In the embodiment of the disclosure, the area of the position region where the face is located may be determined according to the position information of the detected face, namely an area of the detection box may be determined according to the position of the detection box corresponding to the face. The area of the detection box may be determined as the area of the position region where the face is located.

Alternatively, in another embodiment, selection information input by a user may be received to determine a face corresponding to the selection information, the selected face is determined as the face meeting the preset condition, and similarly, a position region corresponding to the selected face is determined as the first sub image. Further, a living-body detection result corresponding to the face selected by the user may be adaptively obtained in the first image. The selection information input by the user may be a box selection operation for the first image, for example, a rectangular box selection operation. In the embodiment of the disclosure, the face in the box selection operation may be directly determined as the face meeting the preset condition, and an image of a region selected by the box selection operation may be determined as the first sub image, or an image corresponding to position information of the face contained in the box selection operation may be determined as the first sub image. No specific limits are made thereto in the disclosure. In addition, a box selection shape corresponding to the box selection operation is not limited to a rectangle, and may also be another shape.

In some embodiments, multiple first sub images may be obtained. That is, multiple faces may meet the preset condition. For example, the multiple faces meeting the preset condition are selected by the box selection operation, and correspondingly, the first sub image corresponding to each of the multiple faces may be obtained.

In operation S32, the first sub image is compared with second sub images corresponding to faces detected in the second image to determine the second sub image matched with the first sub image.

In some embodiments, the face detection result of the second image may be obtained by performing face detection processing on the second image, and may include whether the second image include a face or not and position information of the faces in the second image. Correspondingly, the second sub image corresponding to a position region of each face in the second image may be obtained based on the position information of the faces in the second image, namely an image of the position region corresponding to the position information of each face in the second image is determined as the second sub image. Therefore, the first sub image may be matched with each second sub image to obtain the second sub image matched with the first sub image. The first sub image matching with the second sub image refers to that the face in the first sub image and the face in the second sub image are faces of the same target person. For example, a similarity between features of each first sub image and each second sub image may be obtained, and the second sub image whose similarity is greater than a first threshold is determined as the second sub image matched with the first sub image. In an example, the face meeting the preset condition in the first image may be a face A. For example, the face A is a face having a position region with the largest area in the first image. A first sub image corresponding to the face A may be determined according to position information of the face A. The second image may include faces B, C and D, and correspondingly, second sub images corresponding to the faces B, C and D in the second image respectively may be determined according to position information of the detected faces B, C and D. Then, the first sub image of the face A may be matched with the second sub images of the faces B, C and D respectively. For example, similarities between a face feature corresponding to the first sub image of the face A and face features of the second sub images of the faces B, C and D may be obtained, and whether there is a face matched with the face A in the faces B, C and D may be determined based on the similarities, namely whether there is a second sub image matched with the first sub image may be correspondingly determined. If there is a face whose similarity to the face feature of A is greater than the first threshold in the faces B, C and D, the second sub image corresponding to the face with the highest similarity may be determined as the second sub image matched with the first sub image. For example, the similarity between the face features of faces A and B is 98%, the similarity between the face features of faces A and C is 50%, the similarity between the face features of faces A and D is 85%, and the similarity threshold may be 90%. In such case, it may be determined that the face B is matched with A and correspondingly, the second sub image corresponding to the face B is matched with the first sub image corresponding to the face A. Or, in another embodiment, the first sub image matched with the second sub image may also be determined based on distances between the first sub image and the second sub images.

In operation S33, the first sub image and the second sub image matched with the first sub image are input to a living-body detection neural network to obtain a living-body detection result of the face in the first sub image.

In some embodiments, after the second sub image matched with the first sub image is obtained, the first sub image and the second sub image may be input to the living-body detection neural network, and the living-body detection result indicating whether the faces included in the first sub image and the second sub image are living body is predicted through the living-body detection neural network. The living-body detection neural network may be a convolutional neural network. The living-body detection network may be trained to recognize whether images in the input first sub image and second sub image are living body. The living-body detection network may output a probability that the faces in the first sub image and the second sub image are living body and an identifier indicating whether they are living body or not. For example, the identifier may include a first identifier indicating that the faces in the first sub image and the second sub image are living body and a second identifier indicating that they are non-living body. The first identifier may be 1, and the second identifier may be 0. If the probability is greater than a second threshold, it is indicated that the faces in the first sub image and the second sub image are living body, and in such case, the first identifier is output. If the probability is less than or equal to the second threshold, it is indicated that the faces in the first sub image and the second sub image are non-living body, and in such case, the second identifier is output. In addition, a network structure of the living-body detection neural network is not specifically limited in the embodiment of the disclosure, and may be any neural network capable of achieving the purpose of living-body detection.

Through the embodiment, the living-body detection result of the faces in the matched first sub image and second sub image may further be recognized by use of the living-body detection neural network. In this way, the living-body detection accuracy is improved.

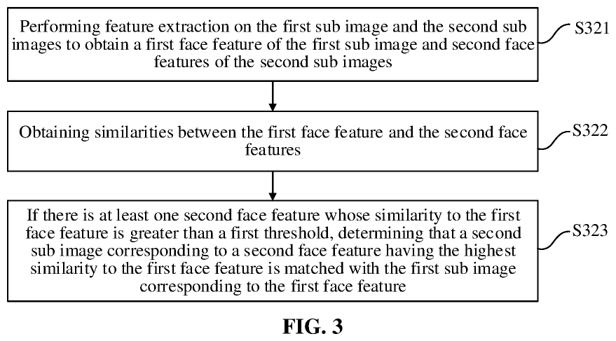

The process of determining the second sub image matched with the first sub image will be described below with an example. FIG. 3 is a flowchart of the operation S32 in a living-body detection method according to an embodiment of the disclosure. The operation that the first sub image is compared with the second sub images corresponding to the faces detected in the second image to determine the second sub image matched with the first sub image includes the following operations S321, S322 and S323.

In operation S321, feature extraction is performed on the first sub image and the second sub images to obtain a first face feature of the first sub image and second face features of the second sub images.

In some embodiments, feature extraction may be performed on the first sub images corresponding to the faces meeting the preset condition in the first image to obtain the first face feature corresponding to each of the first sub images, and feature extraction may be performed on the second sub image corresponding to each face in the second image to obtain the second face feature corresponding to each second sub image. In the embodiment of the disclosure, feature extraction may be performed through a feature extraction network. For example, feature extraction may be performed by use of a convolutional neural network such as a residual network and a pyramid network, which is not limited in the disclosure.

In some embodiments, dimensions of the first face features and the second face features are the same. After first sub images and second sub images are obtained, the first sub images and the second sub images may be regulated to a preset specification to make each sub image to have the same size. Correspondingly, when the first face features and the second face features are obtained by feature extraction, dimensions of the face features are the same.

In operation S322, similarities between the first face features and the second face features are obtained.

In some embodiments, under the condition that the first face features and the second face features are obtained, the similarity between each first face feature and each second face feature may be calculated. For example, the cosine similarity between the first face feature and the second face feature may be calculated, or a Euclidean distance between the first face feature and the second face feature may be calculated to represent the similarity. In another embodiment, the similarity between the first face feature and the second face feature may also be represented through another parameter, and exemplary descriptions are omitted herein.

In operation S323, under the condition that there are second face features whose similarity to the first face feature is greater than a first threshold, it is determined that the second sub image corresponding to the second face feature having a highest similarity to the first face feature is matched with the first sub image corresponding to the first face feature.

In some embodiments, for each first face feature, if there is a second face feature of which the similarity to the face feature is greater than the first threshold, it is indicated that there is a second sub image matched with the first sub image corresponding to the first face feature. In such case, a second sub image corresponding to a second face feature with a highest similarity may be determined as an image matched with the first sub image, and it is indicated that the two matched images include faces corresponding to the same target person.

In addition, for at least one first face feature, if there is any second face feature of which the similarity to the first face feature is less than the first threshold, it is indicated that there is no second face feature similar to the first face feature, and in such case, it may be indicated that there is no second sub image matched with the first sub image corresponding to the first face feature. When determining that there is no second sub image matched with the first sub image, it may be directly determined that the faces in the first sub image and the second sub image are non-living body, or the living-body detection method may also be re-executed, namely another first image is captured by the first camera and the operations of the living-body detection method is re-executed. Correspondingly, if no second face feature similar to the first face feature is detected after the living-body detection method is re-executed for many times, for example, more than a count threshold, namely no second sub image matched with the first sub image is detected, it may be determined that the faces in the first sub image and the second sub image are non-living body. In such a manner, the influence of factors such as change of the collected image or movement state of a person may be reduced, and the living-body detection accuracy is thereby improved.

In some other implementation modes of the disclosure, the operation that the first sub image is compared with the second sub images corresponding to the faces detected in the second image to determine the second sub image matched with the first sub image may further include the following operations. Distances between a first position of the first sub image in the first image and second positions of the second sub images in the second image are acquired. Responsive to that a distance between the second position of any second sub image and the first position of the first sub image is less than a distance threshold, it is determined that the second sub image is matched with the first sub image.

In the embodiment of the disclosure, first positions of the first sub images in the first image and second positions of the second sub images in the second image may be obtained respectively. The first image and the second image may have the same size. Or, under the condition that the first image and the second image have different sizes, normalization processing may be performed on the first image and the second image to make the normalized first image and second image to have the same size, and thus to obtain first positions of the first sub images in the normalized first image and second positions of the second sub images in the second image. After the first positions and the second positions are obtained, a city block distance between each first position and second position may be calculated. When the city block distance is less than the distance threshold, faces corresponding to the second sub image and first sub image may be determined as faces of the same target person, namely the second sub image is matched with the first sub image, and in such case, it may be determined that the target person corresponding to the face of the first sub image is a living body. If there is no second position of which a city block distance to the first position is less than the distance threshold, it is indicated that there is no second sub image matched with the first sub image, namely there is no face in the second image belonging to the same target person as the face in the first sub image, and in such case, it may be determined that the faces in the first sub image and the second sub image are non-living body. The city block distance may be calculated by: d(i, j)=|X1−X2|+|Y1−Y2|, where d(i, j) represents a city block distance between a point i of a coordinate is (x1, y1) and a point j of a coordinate is (x2, y2).

In the embodiment of the disclosure, the first threshold, the second threshold, the distance threshold and the count threshold may be set numerical values, and will not be specifically limited in the embodiment of the disclosure. For example, in the disclosure, the first threshold may be 90%, the second threshold may be 80%, the count threshold may be a numerical value greater than 1, for example, being 5, and the distance threshold may be 5 or another numerical value. The above is not a specific limit but only an example.

After the second sub image matched with the first sub image is obtained, the matched first sub image and second sub image may be input to the living-body detection neural network to obtain the living-body detection result.

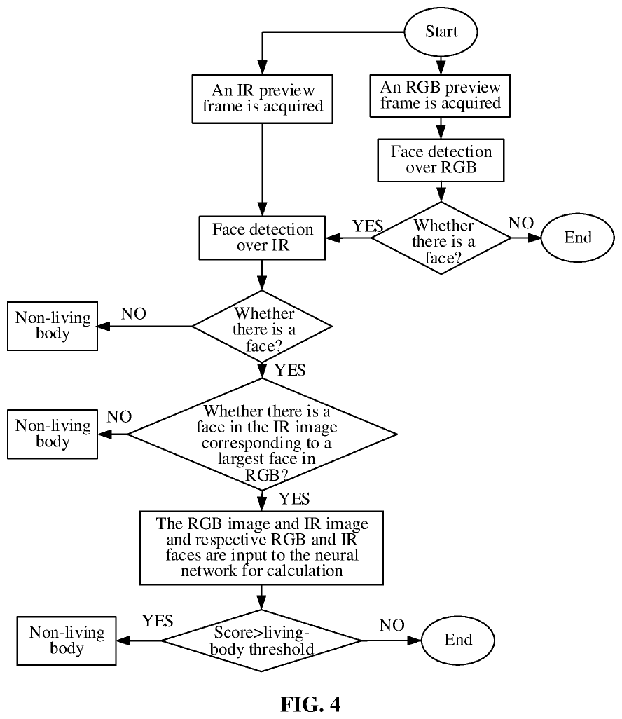

In order to clearly embody the embodiment of the disclosure, the living-body detection process in the embodiment of the disclosure will be described below with an example. FIG. 4 is a schematic diagram of a living-body detection process according to an embodiment of the disclosure. As shown in FIG. 4, descriptions are made by the example that the first camera is an RGB camera and the second camera is an IR camera. A first image, such as an RGB preview frame, captured by the first camera may be acquired, and a second image captured by the second camera may be obtained at the same time. A face in the first image is recognized, namely face detection is performed on the RGB image. If no face is detected, the process is ended, and acquisition of a first image is re-executed. If a face is detected in the first image, the second image captured by the second camera may be acquired, and face detection is performed on the second image. If no face is detected in the second image, it may be determined that the face in the first image is a non-living body. If a face is detected in the second image, then a face with a largest area in the first image may be determined as a face meeting a preset condition, and a face matched with the face with the largest area in the second image is determined, namely a second sub image matched with a first sub image corresponding to the face with the largest area may be determined. Further, the matched first sub image and second sub image are input to the living-body detection neural network to obtain a living-body detection result. If an obtained probability score is greater than the second threshold (a living-body threshold), it may be determined that the faces in the matched first sub image and second sub image are living body, or otherwise they are non-living body. In addition, if no second sub image matched with the first sub image is detected in the second image, it may be determined that the face corresponding to the first sub image is a non-living body, or under the condition that a count of re-executing the living-body detection method exceeds the count threshold, if no second sub image matched with the first sub image is detected, it may be determined that the face in the first sub image is a non-living body.

From the above, according to the embodiment of the disclosure, the first image captured by the first camera may be acquired at first; under the condition that the face is detected in the first image, the second image different from the first image is captured by the second camera; and the living-body detection result is further obtained according to the face detection result of the second image. In the embodiment of the disclosure, living-body detection is performed by use of images captured by a binocular camera, namely the face detection results of the images captured by the two types of cameras are combined to obtain the living-body detection result, so that the living-body detection accuracy is improved. In addition, in the embodiment of the disclosure, the binocular camera (the first camera and the second camera) may be adopted, so that more policies and determinations methods are adopted to prevent the attack from a non-living body, for example, an attack such as an electronic screen can be easily determined according to characteristics of IR imaging, and the attack from a non-living body can be prevented effectively.

From the above, in the embodiment of the disclosure, the first image captured by the first camera may be acquired at first; under the condition that the face is detected in the first image, the second image captured by the second camera and different from the first image is acquired; and the living-body detection result is obtained according to the matching result of the faces detected in the first image and the second image. In the embodiment of the disclosure, living-body detection is performed by use of images captured by a binocular camera, namely the face detection results of the images captured by the two types of cameras are combined to obtain the living-body detection result, so that the living-body detection accuracy is improved.

It can be understood by those skilled in the art that, in the method of the specific implementation modes, the writing sequence of each step does not mean a strict execution sequence and is not intended to form any limit to the implementation process and a specific execution sequence of each step should be determined by functions and probable internal logic thereof.

It can be understood that each method embodiment mentioned in the disclosure may be combined to form combined embodiments without departing from principles and logics. For saving the space, elaborations are omitted in the disclosure.

In addition, the disclosure also provides a device for detecting a living body, an electronic device, a computer-readable storage medium and a program. All of them may be configured to implement any of the operations in the method for detecting a living body provided in the disclosure. Corresponding technical solutions and descriptions refer to the corresponding records in the method part and will not be elaborated.

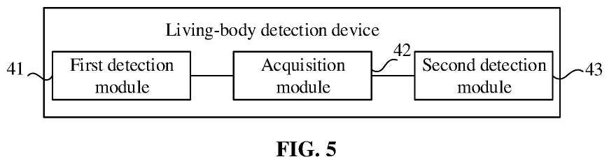

FIG. 5 is a block diagram of a device for detecting a living body according to an embodiment of the disclosure. As shown in FIG. 5, the device for detecting a living body includes a first detection module 41, an acquisition module 42 and a second detection module 43.

The first detection module 41 is configured to acquire a first image captured by a first camera and perform face detection processing on the first image.

The acquisition module 42 is configured to acquire a second image captured by a second camera responsive to detecting that the first image includes a face, where the first camera and the second camera are different types of cameras.

The second detection module 43 is configured to perform face detection processing on the second image and, obtain, responsive to detecting that the second image includes a face, a living-body detection result based on a matching result of the face detected in the first image and the face detected in the second image.

In some embodiments, the acquisition module is configured to acquire the second image captured by the second camera in at least one of the following manners.

The second image captured by the second camera is acquired in condition that the first image is captured by the first camera.

The second image captured by the second camera is acquired in a case of detecting that the first image includes the face.

In some embodiments, the second detection module is further configured to, determine that the face in the first image is a non-living body responsive to detecting that the second image includes no face.

In some embodiments, the second detection module further includes an acquisition unit, a matching unit and a living-body detection unit.

The acquisition unit is configured to acquire a first sub image corresponding to a face meeting a preset condition in the first image.

The matching unit is configured to compare the first sub image and second sub images corresponding to faces detected in the second image to determine a second sub image matched with the first sub image.

The living-body detection unit is configured to input the first sub image and the second sub image matched with the first sub image to a living-body detection neural network to obtain a living-body detection result of the face in the first sub image.

In some embodiments, the acquisition unit is further configured to obtain a first sub image corresponding to a face with a largest area based on position information of each face in the first image.

In some embodiments, the matching unit is further configured to perform feature extraction on the first sub image and the second sub images to obtain a first face feature of the first sub image and second face features of the second sub images,

obtain similarities between the first face feature and the second face features, and

under the condition that there are second face features whose similarity to the first face feature is greater than a first threshold, determine that a second sub image corresponding to the second face feature with a highest similarity to the first face feature is matched with the first sub image corresponding to the first face feature.

In some embodiments, the matching unit is further configured to acquire distances between a first position of the first sub image in the first image and second positions of the second sub images in the second image, and

under the condition that a distance between the second position of any second sub image and the first position of the first sub image is less than a distance threshold, determine that the second sub image is matched with the first sub image.

In some embodiments, the matching unit is further configured to, under the condition that the second image includes no second sub image matched with the first sub image, re-execute acquisition of the first image and performing living-body detection.

In some embodiments, the matching unit is further configured to, under the condition that a count of re-executing the living-body detection exceeds a count threshold, determine that the living-body detection result is a non-living body.

In some embodiments, the first detection module is further configured to re-execute acquisition of the first image captured by the first camera responsive to detecting that the first image comprises no face.

In some embodiments, the first camera is an RGB camera, and the second camera is an IR camera.

In some embodiments, functions or modules of the device provided in the embodiment of the disclosure may be configured to execute the method described in the method embodiment and specific implementation thereof may refer to the descriptions about the method embodiment and, for simplicity, will not be elaborated herein.

The embodiments of the disclosure also disclose a computer-readable storage medium, in which a computer program instruction is stored, the computer program instruction being executed by a processor to implement the method. The computer-readable storage medium may be a non-transitory computer-readable storage medium.

The embodiments of the disclosure disclose an electronic device, which includes: a processor; and a memory configured to store instructions executable by the processor, where the processor is configured to implement the method as mentioned above.

The electronic device may be provided as a terminal, a server or a device in another form.

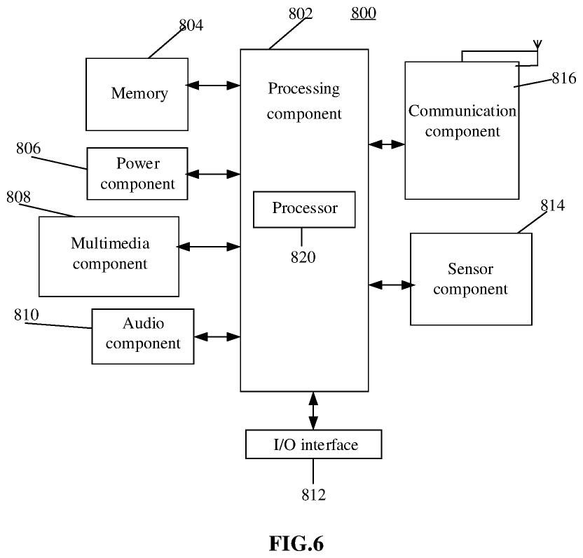

FIG. 6 is a block diagram of an electronic device according to an embodiment of the disclosure. For example, the electronic device 800 may be a terminal such as a mobile phone, a computer, a digital broadcast terminal, a messaging device, a gaming console, a tablet, a medical device, exercise equipment and a PDA.

Referring to FIG. 6, the electronic device 800 may include one or more of the following components: a processing component 802, a memory 804, a power component 806, a multimedia component 808, an audio component 810, an Input/Output (I/O) interface 812, a sensor component 814, and a communication component 816.

The processing component 802 typically controls overall operations of the electronic device 800, such as the operations associated with display, telephone calls, data communications, camera operations, and recording operations. The processing component 802 may include one or more processors 820 to execute instructions to perform all or part of the steps in the abovementioned method. Moreover, the processing component 802 may include one or more modules which facilitate interaction between the processing component 802 and the other components. For instance, the processing component 802 may include a multimedia module to facilitate interaction between the multimedia component 808 and the processing component 802.

The memory 804 is configured to store various types of data to support the operation of the electronic device 800. Examples of such data include instructions for any application programs or methods operated on the electronic device 800, contact data, phonebook data, messages, pictures, video, etc. The memory 804 may be implemented by a volatile or non-transitory storage device of any type or a combination thereof, for example, a Static Random-Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk or an optical disk.

The power component 806 provides power for various components of the electronic device 800. The power component 806 may include a power management system, one or more power supplies, and other components associated with generation, management and distribution of power for the electronic device 800.

The multimedia component 808 includes a screen providing an output interface between the electronic device 800 and a user. In some embodiments, the screen may include a Liquid Crystal Display (LCD) and a Touch Pad (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action but also detect a duration and pressure associated with the touch or swipe action. The touch sensors may not only sense a boundary of a touch or swipe action but also detect a duration and pressure associated with the touch or swipe action. The front camera and/or the rear camera may receive external multimedia data when the electronic device 800 is in an operation mode, such as a photographing mode or a video mode. Each of the front camera and the rear camera may be a fixed optical lens system or have focusing and optical zooming capabilities.

The audio component 810 is configured to output and/or input an audio signal. For example, the audio component 810 includes a Microphone (MIC), and the MIC is configured to receive an external audio signal when the electronic device 800 is in the operation mode, such as a call mode, a recording mode and a voice recognition mode. The received audio signal may further be stored in the memory 804 or sent through the communication component 816. In some embodiments, the audio component 810 further includes a speaker configured to output the audio signal.

The I/O interface 812 provides an interface between the processing component 802 and a peripheral interface module, and the peripheral interface module may be a keyboard, a click wheel, a button and the like. The button may include, but not limited to: a home button, a volume button, a starting button and a locking button.

The sensor component 814 includes one or more sensors configured to provide status assessment in various aspects for the electronic device 800. For instance, the sensor component 814 may detect an on/off status of the electronic device 800 and relative positioning of components, such as a display and small keyboard of the electronic device 800, and the sensor component 814 may further detect a change in a position of the electronic device 800 or a component of the electronic device 800, presence or absence of contact between the user and the electronic device 800, orientation or acceleration/deceleration of the electronic device 800 and a change in temperature of the electronic device 800. The sensor component 814 may include a proximity sensor configured to detect presence of an object nearby without any physical contact. The sensor component 814 may also include a light sensor, such as a Complementary Metal Oxide Semiconductor (CMOS) or Charge Coupled Device (CCD) image sensor, configured for use in an imaging application. In some embodiments, the sensor component 814 may also include an acceleration sensor, a gyroscope sensor, a magnetic sensor, a pressure sensor or a temperature sensor.

The communication component 816 is configured to facilitate wired or wireless communication between the electronic device 800 and another device. The electronic device 800 may access a communication-standard-based wireless network, such as a Wireless Fidelity (WiFi) network, a 2nd-Generation (2G) or 3rd-Generation (3G) network or a combination thereof. In an exemplary embodiment, the communication component 816 receives a broadcast signal or broadcast associated information from an external broadcast management system through a broadcast channel In an exemplary embodiment, the communication component 816 further includes a Near Field Communication (NFC) module to facilitate short-range communication. For example, the NFC module may be implemented based on a Radio Frequency Identification (RFID) technology, an Infrared Data Association (IrDA) technology, an Ultra Wide Band (UWB) technology, a Bluetooth (BT) technology and another technology.

In the exemplary embodiment, the electronic device 800 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors or other electronic components, and is configured to execute the abovementioned method.

In the exemplary embodiment, a non-transitory computer-readable storage medium is also provided, for example, a memory 804 including computer program instructions. The computer program instructions may be executed by a processor 820 of an electronic device 800 to implement the abovementioned method.

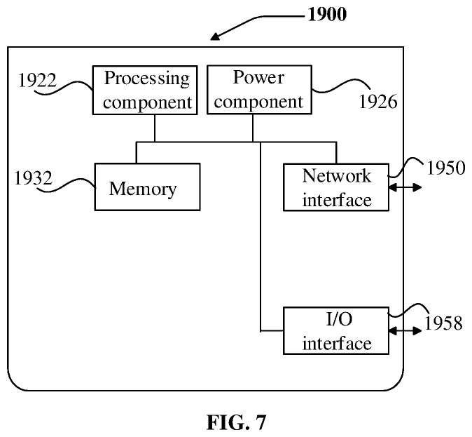

FIG. 7 is a block diagram of another electronic device according to an embodiment of the disclosure. For example, the electronic device 1900 may be provided as a server. Referring to FIG. 7, the electronic device 1900 includes a processing component 1922, further including one or more processors, and a memory resource represented by a memory 1932, configured to store an instruction executable for the processing component 1922, for example, an application program. The disclosure program stored in the memory 1932 may include one or more than one module of which each corresponds to a set of instructions. In addition, the processing component 1922 is configured to execute the instruction to execute the abovementioned method.

The electronic device 1900 may further include a power component 1926 configured to execute power management of the electronic device 1900, a wired or wireless network interface 1950 configured to concatenate the electronic device 1900 to a network and an I/O interface 1958. The electronic device 1900 may be operated based on an operating system stored in the memory 1932, for example, Windows Server™, Mac OS X™, Unix™, Linux™, FreeBSD™ or the like.

In the exemplary embodiment, a non-transitory computer-readable storage medium is also provided, for example, a memory 1932 including a computer program instruction. The computer program instruction may be executed by a processing component 1922 of an electronic device 1900 to implement the abovementioned method.

The disclosure may be a system, a method and/or a computer program product. The computer program product may include a computer-readable storage medium, in which a computer-readable program instruction configured to enable a processor to implement each aspect of the disclosure is stored.

The computer-readable storage medium may be a physical device capable of retaining and storing instructions used by an instruction execution device. For example, the computer-readable storage medium may be, but not limited to, an electric storage device, a magnetic storage device, an optical storage device, an electromagnetic storage device, a semiconductor storage device or any appropriate combination thereof. More specific examples (non-exhaustive list) of the computer-readable storage medium include a portable computer disk, a hard disk, a Random Access Memory (RAM), a ROM, an EPROM (or a flash memory), an SRAM, a Compact Disc Read-Only Memory (CD-ROM), a Digital Video Disc (DVD), a memory stick, a floppy disk, a mechanical encoding device, a punched card or in-slot raised structure with an instruction stored therein, and any appropriate combination thereof. Herein, the computer-readable storage medium is not explained as a transient signal, for example, a radio wave or another freely propagated electromagnetic wave, an electromagnetic wave propagated through a wave guide or another transmission medium (for example, a light pulse propagated through an optical fiber cable) or an electric signal transmitted through an electric wire.

The computer-readable program instruction described here may be downloaded from the computer-readable storage medium to each computing/processing device or downloaded to an external computer or an external storage device through a network such as the Internet, a Local Area Network (LAN), a Wide Area Network (WAN) and/or a wireless network. The network may include a copper transmission cable, optical fiber transmission, wireless transmission, a router, a firewall, a switch, a gateway computer and/or an edge server. A network adapter card or network interface in each computing/processing device receives the computer-readable program instruction from the network and forwards the computer-readable program instruction for storage in the computer-readable storage medium in each computing/processing device.

The computer program instruction configured to execute the operations of the disclosure may be an assembly instruction, an Instruction Set Architecture (ISA) instruction, a machine instruction, a machine related instruction, a microcode, a firmware instruction, state setting data or a source code or target code edited by one or any combination of more programming languages, the programming language including an object-oriented programming language such as Smalltalk and C++ and a conventional procedural programming language such as “C” language or a similar programming language. The computer-readable program instruction may be completely executed in a computer of a user or partially executed in the computer of the user, executed as an independent software package, executed partially in the computer of the user and partially in a remote computer, or executed completely in the remote server or a server. Under the condition that the remote computer is involved, the remote computer may be concatenated to the computer of the user through any type of network including a LAN or a WAN, or, may be concatenated to an external computer (for example, concatenated by an Internet service provider through the Internet). In some embodiments, an electronic circuit such as a programmable logic circuit, an FPGA or a Programmable Logic Array (PLA) may be customized by use of state information of a computer-readable program instruction, and the electronic circuit may execute the computer-readable program instruction, thereby implementing each aspect of the disclosure.

Herein, each aspect of the disclosure is described with reference to flowcharts and/or block diagrams of the method, device (system) and computer program product according to the embodiments of the disclosure. It is to be understood that each block in the flowcharts and/or the block diagrams and a combination of each block in the flowcharts and/or the block diagrams may be implemented by computer-readable program instructions.

These computer-readable program instructions may be provided for a universal computer, a dedicated computer or a processor of another programmable data processing device, thereby generating a machine to further generate a device that realizes a function/action specified in one or more blocks in the flowcharts and/or the block diagrams when the instructions are executed through the computer or the processor of the other programmable data processing device. These computer-readable program instructions may also be stored in a computer-readable storage medium, and through these instructions, the computer, the programmable data processing device and/or another device may work in a specific manner, so that the computer-readable medium including the instructions includes a product including instructions for implementing each aspect of the function/action specified in one or more blocks in the flowcharts and/or the block diagrams.

These computer-readable program instructions may further be loaded to the computer, the other programmable data processing device or the other device, so that a series of operating steps are executed in the computer, the other programmable data processing device or the other device to generate a process implemented by the computer to further realize the function/action specified in one or more blocks in the flowcharts and/or the block diagrams by the instructions executed in the computer, the other programmable data processing device or the other device.

The flowcharts and block diagrams in the drawings illustrate probably implemented system architectures, functions and operations of the system, method and computer program product according to multiple embodiments of the disclosure. On this aspect, each block in the flowcharts or the block diagrams may represent part of a module, a program segment or an instruction, and part of the module, the program segment or the instruction includes one or more executable instructions configured to realize a specified logical function. In some alternative implementations, the functions marked in the blocks may also be realized in a sequence different from those marked in the drawings. For example, two continuous blocks may actually be executed substantially concurrently and may also be executed in a reverse sequence sometimes, which is determined by the involved functions. It is further to be noted that each block in the block diagrams and/or the flowcharts and a combination of the blocks in the block diagrams and/or the flowcharts may be implemented by a dedicated hardware-based system configured to execute a specified function or operation or may be implemented by a combination of a special hardware and a computer instruction.

Each embodiment of the disclosure has been described above. The above descriptions are exemplary, non-exhaustive and also not limited to each disclosed embodiment. Many modifications and variations are apparent to those of ordinary skill in the art without departing from the scope and spirit of each described embodiment of the disclosure. The terms used herein are selected to explain the principle and practical application of each embodiment or improvements in the technologies in the market best or enable others of ordinary skill in the art to understand each embodiment disclosed herein.

### INDUSTRIAL APPLICABILITY

The embodiments of the disclosure relate to the living-body detection method and device, the electronic device and the storage medium. The method includes that: the first image captured by the first camera is acquired, and face detection processing is performed on the first image; responsive to detecting that the first image includes the face, the second image captured by the second camera is acquired, where the first camera and the second camera are different types of cameras; and face detection processing is performed on the second image, and responsive to detecting that the second image includes the face, the living-body detection result is obtained based on the matching result of the face detected in the first image and the face detected in the second image. According to the embodiments of the disclosure, the living-body detection accuracy can be improved.

1. A method for detecting a living body, comprising:
acquiring a first image captured by a first camera, and performing face detection processing on the first image;
acquiring a second image captured by a second camera responsive to detecting that the first image comprises a face, wherein the first camera and the second camera are different types of cameras; and
performing face detection processing on the second image, and obtaining, responsive to detecting that the second image comprises a face, a living-body detection result based on a matching result of the face in the first image and the face in the second image.

2. The method of claim 1, wherein acquiring the second image collected by the second camera comprises at least one of the following manners:
acquiring the second image captured by the second camera in a case that the first image captured by the first camera is acquired; or
acquiring the second image captured by the second camera in a case of detecting that the first image comprises the face.

3. The method of claim 1, further comprising:
determining that the face in the first image is a non-living body responsive to detecting that the second image comprises no face.

4. The method of claim 1, wherein obtaining the living-body detection result based on the matching result of the face in the first image and the face in the second image comprises:
acquiring a first sub image corresponding to a face meeting a preset condition in the first image;
comparing the first sub image and second sub images corresponding to faces detected in the second image to determine a second sub image matched with the first sub image; and
inputting the first sub image and the second sub image matched with the first sub image to a living-body detection neural network to obtain a living-body detection result of the face in the first sub image.

5. The method of claim 4, wherein acquiring the first sub image corresponding to the face meeting the preset condition in the first image comprises:
obtaining a first sub image corresponding to a face having a largest area based on position information of faces in the first image.

6. The method of claim 4, wherein comparing the first sub image and the second sub images corresponding to the faces detected in the second image to determine the second sub image matched with the first sub image comprises:
performing feature extraction on the first sub image and the second sub images to obtain a first face feature of the first sub image and second face features of the second sub images;
obtaining similarities between the first face feature and the second face features; and
in condition that there is at least one second face feature whose similarity to the first face feature is greater than a first threshold, determining that a second sub image corresponding to a second face feature with a highest similarity to the first face feature is matched with the first sub image corresponding to the first face feature,
or,
wherein comparing the first sub image and the second sub images corresponding to the faces detected in the second image to determine the second sub image matched with the first sub image comprises:
acquiring distances between a first position of the first sub image in the first image and second positions of the second sub images in the second image; and
in condition that a distance between a second position of any of the second sub images and the first position of the first sub image is less than a distance threshold, determining that the second sub image is matched with the first sub image.

7. The method of claim 4, wherein obtaining the living-body detection result based on the matching result of the face in the first image and the face in the second image responsive to detecting that the second image comprises the face further comprises:
responsive to detecting that the second image comprises no second sub image matched with the first sub image, re-executing the method for detecting the living body.

8. The method of claim 7, further comprising:
in condition that a count of re-executing the method for detecting the living body exceeds a count threshold, determining that the living-body detection result is a non-living body.

9. The method of claim 1, further comprising:
re-executing acquisition of the first image captured by the first camera responsive to detecting that the first image comprises no face.

10. The method of claim 1, wherein the first camera is a Red-Green-Blue (RGB) camera, and the second camera is an Infrared Radiation (IR) camera.

11. A device for detecting a living body, comprising:
a processor; and
a memory configured to store instructions executable by the processor,
wherein the processor is configured to:
acquire a first image captured by a first camera and perform face detection processing on the first image;
acquire a second image captured by a second camera responsive to detecting that the first image comprises a face, wherein the first camera and the second camera are different types of cameras; and
perform face detection processing on the second image, and obtain, responsive to detecting that the second image comprises a face, a living-body detection result based on a matching result of the face in the first image and the face in the second image.

12. The device of claim 11, wherein the processor is configured to acquire the second image captured by the second camera in at least one of the following manners:
acquiring the second image captured by the second camera in a case that the first image is captured by the first camera; and
acquiring the second image captured by the second camera in a case of detecting that the first image comprises the face.

13. The device of claim 11, wherein the processor is further configured to determine that the face in the first image is a non-living body responsive to detecting that the second image comprises no face.

14. The device of claim 11, wherein the processor is specifically configured to:
acquire a first sub image corresponding to a face meeting a preset condition in the first image;
compare the first sub image and second sub images corresponding to faces detected in the second image to determine a second sub image matched with the first sub image; and
input the first sub image and the second sub image matched with the first sub image to a living-body detection neural network to obtain a living-body detection result of the face in the first sub image.

15. The device of claim 14, wherein the processor is further configured to obtain a first sub image corresponding to a face having a largest area based on position information of faces in the first image.

16. The device of claim 14, wherein the processor is further configured to:
perform feature extraction on the first sub image and the second sub images to obtain a first face feature of the first sub image and second face features of the second sub images;
obtain similarities between the first face feature and the second face features, and
in a case that there is at least one second face feature whose similarity to the first face feature is greater than a first threshold, determine that a second sub image corresponding to a second face feature with a highest similarity to the first face feature is matched with the first sub image corresponding to the first face feature,
or,
wherein the processor is further configured to:
acquire distances between a first position of the first sub image in the first image and second positions of the second sub images in the second image, and
in condition that a distance between a second position of any of the second sub images and the first position of the first sub image is less than a distance threshold, determine that the second sub image is matched with the first sub image.

17. The device of claim 14, wherein the processor is further configured to, in condition that the second image comprises no second sub image matched with the first sub image, re-execute acquisition of the first image and performing living-body detection.

18. The device of claim 17, wherein the processor is further configured to determine that the living-body detection result is a non-living body in condition that a count of re-executing the living-body detection exceeds a count threshold.

19. The device of claim 11, wherein the processor is further configured to re-execute acquisition of the first image captured by the first camera responsive to detecting that the first image comprises no face.

20. A non-transitory computer-readable storage medium, having stored therein computer program instructions, wherein the computer program instructions, when being executed by a processor, cause the processor to implement the following operations:
acquiring a first image captured by a first camera, and performing face detection processing on the first image;
acquiring a second image captured by a second camera responsive to detecting that the first image comprises a face, wherein the first camera and the second camera are different types of cameras; and
performing face detection processing on the second image, and obtaining, responsive to detecting that the second image comprises a face, a living-body detection result based on a matching result of the face in the first image and the face in the second image.
